(19) United States
(12) Patent Application Publication
(10) Pub. No.: US 2018/0264614 A1
(43) Pub. Date: Sep. 20, 2018

(54) LINEAR GUIDING DEVICE FOR A FEED AXIS OF A MACHINE TOOL

(71) Applicant: Cord WINKELMANN, Ritterhude (DE)

(72) Inventors: Cord WINKELMANN, Ritterhude (DE); Gerrit DUMSTORFF, Münster (DE); Walter LAN, Bremen (DE)

(21) Appl. No.: 15/544,522

(22) PCT Filed: Jan. 14, 2016
(86) PCT No.: PCT/EP2016/050695

§ 371 Date: Jul. 19, 2017

(30) Foreign Application Priority Data
Jan. 19, 2015 (DE) 10 2015 100 655.3

(51) Int. Cl. B23Q 17/09; F16C 29/00; G01L 5/00; G01M 13/04

(52) U.S. Cl. CPC B23Q 17/0966; F16C 29/005; G01L 5/0019; F16C 29/0645; F16C 2233/00; F16C 2322/39; G01M 13/045

(57) ABSTRACT

The invention relates to a linear guiding device (1) for a feed axis (2), preferably a machine tool (3), comprising at least the following components:
At least one sensor surface (4) of the linear guiding device (1) for linearly guiding a carriage (5) or a spindle nut (6);
at least one microsensor (7), preferably at least one strain gage (8, 9, 10, 11, 12) and/or at least one resistance temperature sensor (13, 14), for detecting an expansion and/or compression and/or temperature of at least one sensor surface (4), wherein at least one microsensor (7) is permanently connected to at least one sensor surface (4).

With the present invention, a load on a linear guiding device can be directly measured during the machine's operation.

### THE SUBJECT MATTER OF THE INVENTION

The present invention concerns a linear guiding device for a feed axis, ideally for a machine tool, as a thin-film application method for a microsensor on a linear guiding device, a method for introducing a microsensor in a linear guiding device and a computer-executable method for detecting loads in a linear guiding device with at least one microsensor. The invention can also be used in particular in the field of press shops, plant construction and for special machines. The main focus of the invention is on rolling element systems, as they have a much larger market share. Hereinafter, examples with rolling element systems will be shown. However, the invention can also be easily transferred to hydrostatic systems for example.

### STATE OF THE TECHNOLOGY

In order to optimize the availability and life-cycle of the machines and systems, or individual components, which therefore reduces costs, their users expect an ever higher degree of plant monitoring. Therefore, intelligent machine monitoring, known as condition monitoring, is strived for in the industry. For this purpose, a location-resolving sensor system, which is permanently arranged in a machine, is needed. Hereby, significant cost savings can be achieved by not maintaining preventive, i.e. too early, or reactive, i.e. too late, condition-oriented maintenance.

An example taken from the dissertation by Dr. Wieland H. Klein, “State Supervision of Roller Profile Rail Guiding and Threading”, RWTH Aachen, 2011, presents a comprehensive overview of the state of research on condition monitoring, which is quoted below in order to illustrate the underlying task. Condition monitoring is intended to increase failure safety by determining a failure time of used parts, to make the remaining time of a system determinable and to increase operating safety. This results in significant cost savings due to the possibility of more appropriate maintenance, optimization of service logistics and personnel requirements as well as lower maintenance measures. Particularly in the area of production with machine tools, even the shortest amount of machine downtime causes very high value losses. Feed axes are responsible for a large proportion of machine failures in machine tools, amounting to nearly 40% [percent]. If the causes of feed axes failure are further reduced, it has been found that the ball screw drives (KGT) and the profile rail guides account for almost 45% of all feed axis failures.

Overload (42%), contamination (26%) and deficient lubrication (20%) are the most common causes of failure in ball screw drives. Mounting errors, such as a misalignment, amount to 12% of failures, where local overloading of the components can occur.

So-called condition monitoring, or machine condition monitoring, is already being used today. However, currently condition monitoring usually takes place at the control panel of the machine. At present, the sensors necessary for component-based monitoring, which are capable of receiving signals directly from stress zones, are not available on the market.

While the first monitoring systems for rotating bearings are already on the market, or about to be introduced onto the market in the near future, no monitoring systems for profile rail guides or ball screw drives are currently available. The systems far bearings are sensor-based processes. The work is relevant in the field of body acoustic measurement or acoustic surface acoustic measurements. The movements are, of course, periodic processes. In the case of profile rail guides and ball screw drives, however, they are linear and therefore not directly periodic process movements. For condition monitoring systems, this means that other evaluation algorithms must be bypassed, and that vibration transducers, like the ones used in rotating bearings, are only conditionally suitable for monitoring linear technology elements. In addition, body-borne sound has the great disadvantage that damage must be present in order for the signal to change.

There are scientific studies on the controllability of profile rails and ball screws. All known preliminary work is based on the fact that vibration measurement (for example, body sound) is carried out and the data obtained is interpreted or the temperature is measured. However, due to the structural differences between test stands and different production systems, there is a discrepancy between the respective measurement values and measurement results so that an individual adaptation of the measuring system must be carried out for each component and each machine. If the operating parameters change, such as re-lubrication after a lubrication film break, the measuring system needs to be recalibrated. The load on the components during production has an effect on the measuring result, so the measurements have to be carried out in separate measurement runs.

In principle, two types of system monitoring can be distinguished: firstly, monitoring using the data provided by the machine control system and, secondly, monitoring using external sensors.

Monitoring on the basis of the data provided by the machine control system is carried out by using corresponding software (for example, ePS Network Services from Siemens AG). The main focus is on monitoring the feed axes. However, the sampling frequency in these systems is limited by the position control clock to between 250 Hz [Hertz] and 1 kHz [kilohertz]. As signals based on the Shannon theorem can only be analyzed up to a maximum of half the frequency bandwidth, higher-frequency influences can only be detected by means of external sensors with data preprocessing. These sensors are often body-borne sensors or temperature sensors, which are attached to the machine at selected points.

During plant monitoring, the microchip, which converts the mechanical oscillation into an electrical signal, is housed to protect it against environmental influences and for better handling, and is then fixed to the machine or a machine component. With this type of monitoring, however, there is a great need to interpret the data because the measuring location does not necessarily coincide with the location of the signal cause. Therefore, without artificial intelligence, it is not easy to say which of the gears or bearings of an engine is responsible for an increase in the oscillation amplitude in a particular frequency range due to damage.

Alternatively, measurements are made indirectly. Indirect measurements are done in two ways: firstly by evaluating control-internal data and/or by the use of external sensors. When using external sensors, microsensors or thin film sensors are used.

The software module ePS Network Services from Siemens AG supports the implementation of state-oriented maintenance in the case of machine tools and production machines with CNC control. The web-based, cross-company services ensure that both our own service-specialists and the responsible maintenance staff at the operator's site can access the operating information and fault information of the connected machines round the clock. The basis of these services is an Internet-based platform. It supports cross-company service processes and support processes and enables secure communication.

The software tool is used by many machine tool manufacturers because it can be used as an optional equipment feature without a sensory extracting wall. It is intended to optimize maintenance by pointing out necessary maintenance activities such as cleaning, inspection and repair at an early stage. The machine operator can cyclically record the state of the feed axes by means of automated test methods and therefore obtains information about the current state of the machine. When in standard configuration, the machine diagnosis is based exclusively on the evaluation of internal control signals. This includes the motor current and the position values as well as all data, signals and states of external sensors stored in the PLC. This makes it possible to monitor peripheral modules using internal machine sensors. The main focus of the system is monitoring the feed axes. For this purpose, test runs are carried out in a machine at defined times. These are essentially: constant acceleration tests, universal tests and circular tests.

By means of uniform running tests, damage as well as mechanical and tribological changes on the feed axes are recorded. The universal axis test is used to measure the friction state. The circular-shaped test is intended recognize whether fault directions of the axes, a loose or not optimally parameterized drive control is present.

The great advantage of the software-based system is that it does not require any external sensors. In addition, various users, such as internal and external services, can access the services via the Internet.

Disadvantages are that such a system is limited in its speed to the position controller clock of 250 Hz to 1 kHz, whereby no higher-frequency influences can be detected on the basis of the Shannon theorem. In addition, only the damage, but not the underlying load, is measured. As part of the dissertation, cited here, entitled “Condition monitoring of roller profile rail guides and thread drives” it was also found that, for example, the characteristic value of the motor current as the signal input value is not a reliable indicator of problems with the feed axes, as shown in DE 10 2007 038 890 A1. A further disadvantage is that the measurements take place in separate measurement runs and not during operation. Especially in high-production machines, this means a lower production capacity and therefore higher costs.

There are numerous providers of monitoring systems based on the interpretation of sensor data. The machine condition indicator (MCI) from Prometec is mentioned here as an example. The system uses a combination of control data and sensor data to generate a statement about the state of the machine and the manufacturing process. In addition to reading internal control data from the CNC control, an additional external acceleration sensor is used on the spindle. The evaluation unit continuously detects the occurring vibrations within the machine. On the one hand, the quality of the process can be assessed and, on the other hand, the machine can be monitored for dangerous conditions such as collisions or incorrectly tensioned tools (unbalance). When a critical condition occurs, the machine's emergency stop can be used. To assess the machine's state, additional spindle test programs and feed axis test programs are carried out at regular intervals. The machine state is assessed by forming characteristic values during the test programs. The failure of a component is detected by exceeding a previously manually set limit value in the characteristic values.

The advantage of these sensor-based monitoring systems lies in their widespread use and the comparatively favorable sensors, which can be easily mounted, for example, by screwing or gluing.

As with monitoring based on the machine data, separate measurement runs have to be carried out here because the loads during the production process significantly influence the measurement. An exception is the measuring system BeMoS from BestSens AG, which monitors the condition of rotating bearings with the help of acoustic surface waves. The manually defined characteristic values have to be reset after structural changes, for example after an exchange of components and after a re-lubrication due to the occurrence of deficient lubrication. A major disadvantage is also that a high interpretation expenditure must be operated in order to close the measured signal and the cause of the damage and its location. This interpretation cannot be sufficiently automated.

The disadvantages described in the aforementioned state of the technology are at least partially solved by means of the invention described below. The features of the invention will become apparent from the independent claims, to which advantageous embodiments are presented in dependent claims. The features of the claims can be combined in any technically meaningful manner, whereby for this purpose the explanations from the following description, as well as features from the figures, which comprise supplementary embodiments of the invention, may also be referred to.

### SUMMARY OF THE INVENTION

The invention relates to firstly, a linear guiding device for a feed axis, preferably a machine tool, comprising of at least the following components:
At least one sensor surface of the linear guiding device, in which the linear guiding device is designed for the linear guidance of a carriage or a spindle nut;
At least one microsensor, preferably at least one strain gage and/or at least one resistance temperature sensor, for detecting expansion and/or compression and/or temperature of at least one sensor surface. The linear guiding device is characterized in that at least one microsensor is permanently connected to at least one sensor surface.

Secondly, the invention relates to a method for thin-film application of a microsensor on a linear guiding device, comprising of at least the following steps:

a. Applying an electrically insulating first layer on a sensor surface to be detected by a linear guiding device;

b. Applying an electrically conductive second layer on the first layer;

c. Patterning the second layer;

d. Applying an electrically insulating and mechanically robust third layer by means of which the second layer is electrically insulated externally and mechanically protected, the third layer being preferably formed from aluminum oxide; and

e. Before, during, or after step b. Applying line connections for connecting the second layer to a measuring device.

Thirdly, the invention relates to a method for introducing a microsensor to a linear guiding device, wherein the microsensor is preferably a film sensor comprising at least the following steps:

i. Arranging the microsensor at a predetermined position;

ii. Casting and/or soldering at least a part of the linear guiding device means to the positioned microsensor;

iii. Before, during or after step i. Positioning line connections on a microsensor for a measuring device.

Fourthly, the invention relates to a computer-executable method for detecting loads in a linear guiding device with at least one microsensor, as well as a computer-readable device by means of which the method can be carried out, the method mainly being characterized in that a plurality of strain gages are provided and the deformation and the position of the strain gages being stored, and wherein on the basis of the respective resistance changes of the strain gages, together with the stored values of the shape, the shape of the strain gages, E module and position, the applied linear force and/or the applied torque are calculated, preferably taking the extrapolation of the service life and/or measures for increasing the service life.

### DETAILED DESCRIPTION OF THE INVENTION

The invention relates to a linear guiding device for a feed axis, preferably a machine tool, comprising at least the following components:
At least one sensor surface of the linear guiding device, in which the linear guiding device is designed for the linear guidance of a carriage or a spindle nut;
At least one microsensor, preferably at least one strain gage and/or at least one resistance temperature sensor, for detecting expansion and/or compression and/or temperature of at least one sensor surface. The linear guiding device is characterized in that at least one microsensor is permanently connected to at least one sensor surface.

A linear guiding device is arranged for a feed axis, generally at least one of the translatory axes x-axis, y-axis and z-axis. Such a linear guiding device is suitable for feeding a tool, for example a milling head, and for feeding a work table on which a workpiece that needs to be processed can be accommodated and fixed, but also, for example, a machine-internal tool exchange bearing and a movable cooling system and a movable exhaust system machine tool can be used. Other uses are, for example, in press shops, plant construction and special machine construction. The sizes, materials and general mechanical properties as well as the guiding precision are adapted to the respective application. For example, the linear guiding device is a profile rail for guiding and moving a carriage or a spindle for a translationally movable spindle nut.

The sensor surface of a linear guiding device is a surface which is generally not directly involved in the bearing, for example a carriage. As a rule, there is not a contact surface for a rolling element and not an (antagonistic) surface for a hydrostatic pocket. On the contrary, the sensor surface is, for example, a rear side of a contact surface or, preferably by way of a corner, adjoins to a contact surface. Preferably, the sensor surface is selected so that particularly large deformations occur, preferably at the (inner or outer) end of a cantilevered structure. In the case of a profile rail, the preferred sensor surface is, for example, the surface opposite the joining surface, into which the countersunk holes for screw heads are usually inserted for screwing the profile rail. A further possible sensor surface is a surface laterally to the joining surface, preferably between bracing bearing surfaces. Such surfaces lie close to the loads and are located in the region of the profile rail which forms an abutment, which is therefore subjected to deformation upon loading. In the case of a spindle, the preferred sensor surface is the outermost peripheral surface on the thread drive, i.e. the outer surfaces of the flanges of the spiral. These are, on the one hand, easily accessible from the outside and, on the other hand, not direct supports for bearing elements. However, they are subject to the direct influence of loads in the plant. Preferably, the sensor surface is only the thread-free surface between the thread drive and the spindle drive. Due to always having information available on the position of a driven spindle nut, the location and the cause of the load can nevertheless be easily determined.

Sensor surfaces, in a special embodiment, are also bearing surfaces, which are directly loaded, for example by rolling elements. For this, mechanically particularly robust microsensors are used. In one embodiment, these are strain gages with a meandering structure in a classical construction. Particularly preferred are microsensors of so-called a: CH (amorphous carbon, also called diamond-like carbon, DLC) between electrodes of a hard metal, preferably chromium, which measure in the direction of loading. The (used) measuring range of these directly loaded microsensors is, in one embodiment, only outside the direct load. A microsensor of this type is also sufficiently unstable to be loaded between measuring times of, for example, a rolling element. Alternatively, the direct load of, for example, a rolling element can also be detected. In the latter case, the measurement is rendered useless by a local deformation of the microsensor beyond mere mechanical stability.

A microsensor is a sensor which has microstructures in the range of usually less than 1 mm [mm] and whose physical material properties produce an electrical signal when the formed microstructure is influenced. An electrical signal is a detectable deviation from a standard state. For example, a microsensor comprises at least one strain gage in which the electrical resistance can be varied as a result of geometrical deformation of the microstructure, in other words, the geometrical effect, especially in the case of metallic materials, and/or strain at molecular level, i.e. piezo-resistively, in particular in semiconductor materials. In order to determine the direction of the deformation, as a rule a meander-shaped structure is selected which meanders transversely in a single measuring direction, i.e. the conductor tracks the strain gage extended along the measuring direction and has lateral connecting pieces alternately at the top and at the bottom. Therefore, cross-flows are negligible or eliminated by (partial) symmetry for many applications. A capacitive strain gage can also be used, these being generally not flat, i.e. as a layer sensor, and this must be taken into account when the strain gage is placed. Expansion or compression of the surface in the μm range [micrometer range] can be detected with a strain gage strip as a result of close contact with a surface. In addition, temperature changes can also be measured with a strain gage as the material has a temperature-dependent specific resistance. Such strain gages can be applied directly by thin-film application, for example by sputtering, vapor deposition, lamination, printing, electrodeposition and/or spraying. Strain gages can also be connected as film sensors as finished microsensors or partial components of microsensors, for example by gluing, to the linear guiding device. Foil strain gages are preferably adhesively bonded and wired manually.

Advantageous measuring materials are alloys such as constantan (54% copper, 45% nickel, 1% manganese), NiCr [nickel chromium] or PtW [platinum tungsten], but it is also possible to use layers of a semiconductor material, for example Si [silicon].

A microsensor preferably comprises a plurality of individual sensor elements, preferably interconnected on the microplane, such as a plurality of strain gages with a single measuring orientation and/or at least one resistance temperature sensor. In this case, the sensor elements are preferably interconnected for the production of cleaned measuring signals and/or serve in each case to detect a single dearly defined measured value, for example a strain gage for detecting an expansion or compression in a spatial direction.

Furthermore, simple resistance temperature sensors, which change their resistance in the event of temperature changes, preferably proportionally, can be used supplementarily or alternatively. In particular, it is therefore possible to deduce increased friction in the region of a temperature increase.

Resistance temperature sensors are preferably used in combination with strain gages. An additional strain gage is used as a resistance temperature sensor in order to eradicate or calculate out temperature-dependent transients. A Wheatstone bridge circuit is preferably used in order to be able to accommodate small changes in resistance adjusted for cross-fluxes.

At least one microsensor is arranged close to a sensor surface, so that the deformation or temperature change of the sensor surface is transmitted to the microsensor in as large a quantity as possible. In a further variant, at least one microsensor is arranged directly on the sensor surface, for example glued as a film sensor or as a surface sensor, applied directly by thin-film or print technology. At least one microsensor remains on-site over the service life of the machine tool or of the respective linear guiding device and is therefore permanently equipped to detect loads by way of suitable measuring electronics.

A disadvantage of the previously known condition monitoring methods is that the force which acts on the components and is the cause of all further damage has not yet been measured. As indicated above, overload and mounting errors (which in turn generate a non-optimal load distribution) account for over 50% of all failures. The disadvantage is that so far only progressive damage, but not the underlying stresses are measured by these methods.

The great advantage of measuring the force against vibration measurements is that it can be measured while the machine is being operated and no separate test runs have to be carried out. The operating parameters are measured directly, do not distort the measuring result and are available in real time.

In contrast to this, the microsensors are arranged in or on a linear guiding device, preferably for profile rail sensor surfaces and for sensor surfaces on the circumference of ball thread rods. Therefore, both deformation and temperature can be spatially resolved and measured in a time-resolved manner. By continuously measuring these values, the load history of a component can be completely recorded.

The great advantage of monitoring with sensory surfaces is that, on the one hand, the possible high spatial resolution as well as the fact that the forces occurring cannot be measured directly on the component plane. As a result, the actual component can be monitored as well as the force introduction into structural components such as, for example, the machine bed. If this is caused by an overload it usually results in total loss of the machine. In addition, such microsensors measure during operation, so that no productive machine time is lost for measurement runs.

In a further advantageous embodiment of the linear guiding device, at least one microsensor has at least one strain gage having a single measuring orientation in at least one of the following assemblies:
Transversely on a central line between two bearing sides;
At least two strain gages each with the measuring orientation transverse to and equidistant to a central line between two bearing sides;
With the measuring orientation along a central line between two bearing sides.

The invention comprises at least a strain gage, preferably numerous strain gages, which is applied or produced on (or in) the linear guiding device in order to measure the loads acting during operation and to determine from these measured values the remaining life of the monitored component.

A guide rail of a linear guiding device is screwed either from above or from below, for example with a machine tool. The guide carriage or carriage runs on balls (ball guide), cylindrical rolling elements (roller guide) or is hydrostatically supported over the guide rail and therefore performs a linear movement.

The guide rail deforms as a result of the forces and torques occurring during operation. The deformation is proportional to the force present and/or to the occurring moment and can be detected via at least one strain gage. In order to protect the strain gage against wear and damage, it is better to embed the strain gage either in the material of the guide rail or directly on the sensor surface of the guide rail.

Three different arrangements, described in detail below, are especially recommended and can also be combined with one another.

In principle, the following loading conditions occur:

The carriage rolls around the feed axis, therefore tilting laterally to the feed direction. The carriage nods about the axis transversely to the feed axis, therefore tilting in the feed direction. The carriage is inclined about the vertical axis in respect to the aforementioned axes. In addition, purely translational movements are also possible in the two bearing directions, that is to say transversely to the feed direction. Accordingly, tensile loads and pressure loads occur on the guide rail.

In the first arrangement, two strain gages lie on the right and left of the guide rail axis with their measuring orientation transversely to the central axis. The respective positioning differs depending on the model of the guide and can be found through simulations or practical tests. In the case of a tensile load on the guide rail (load in the direction of release of the fastening screws of the guide rail), both strain gages are compressed, stretched under pressure load on the guide rail (loading in the direction of tightening of the fastening screws of the guide rail). In the case of a force introduction from the side of the guide rail (loading transversely to a fastening screw), a sensor element is compressed, the other is stretched; the strain gages do the same when a moment acts about the longitudinal axis of the guide. With this arrangement, in addition to the absolute height, the direction of the force introduction can also be determined.

Secondly, only a strain gage which has the same measuring orientation as in the first arrangement, preferably on the center line of the guide rail, is used. This can only differ between tensile load and compressive loading, i.e. compression or expansion. Lateral forces and moments are only detected to a limited extent. However, this variant represents a cost-effective alternative. A temperature drift can be calculated on the software side during signal processing and is often supplied by the manufacturer of the microsensor. A temperature drift, at least initially, has a relatively slow rise, while a strain or compression occurs due to a load with a force comparatively suddenly.

Thirdly, the two strain gages lie, as in the first arrangement, on the left and the right of a central axis, but not in a line transversely to the feed axis, but are arranged staggered in the feed direction. If the guide carriage is above the measuring point formed by the strain gages, they can nevertheless take up all measured values as in the first arrangement. In addition, the speed and the direction of the movement of the carriage are detectable via this arrangement in dynamic use, that is, when the guide carriage moves. Furthermore, two further strain gages are shown in the third arrangement, the measuring orientation of which is rotated by 90° relative to the other two strain gages. Although they do not measure the deformation of the guide rail, they are subject to the same thermal influences as the two measuring strain gages and can thus be used for temperature compensation.

The individual sensor elements are then read out via corresponding electronics. Expediently, they are interconnected in a Wheatstone measuring bridge. The measurement can preferably be read out via a two-wire measurement, three-wire measurement, four-wire measurement or six-wire measurement.

The sensor elements can be read out individually (with or without temperature compensation) (quarter bridge) or in the case of two strain gages (first and third arrangement) in a crossed half bridge, also with or without temperature compensation. In the case of the crossed half bridges, however, the information about laterally acting forces and moments about the longitudinal axis of the guide rail is lost. However, the sensitivity of this circuitry is doubled in comparison with the second arrangement.

With the arrangement of at least one microsensor as proposed, it is also possible to draw conclusions on the carriage, such as the loads and deformations, the temperature as well as production errors and damage. In particular, together with a data sheet supplied by the manufacturer, or FEM model, the deformations determined by means of the microsensors provided can be used for the calculation of the previously described information on the carriage.

The meandering structure also allows temperatures to be measured. Alternatively or additionally thermocouples can be used to measure the temperature. The measurement of the force can also be performed with a piezo element. In the case of a piezo element, as a rule, a ceramic material is used which, owing to its particular crystal structure under load, carries out a deformation which leads to a charge displacement in the crystal. This charge displacement causes a proportional voltage change. This can be used as a measuring signal.

In a further advantageous embodiment of the linear guiding device at least one microsensor is secured by means of at least one of the following manufacturing processes:
At least one of the microsensors being a film sensor and being rolled into the depression. (DE). WIPO Home services World Intellectual Property Organization is;
Embedding or casting at least one microsensor during the casting, preferably the continuous casting, of the linear guiding device;
Extensive gluing of at least one microsensor to the sensor surface; and
Extensive thin film application of the microsensor on at least one sensor surface.

In order to protect the microsensors from wear and damage, it is better to embed them either in the material of the guide rail or to place them on the surface of the rail.

Until now it has not been not possible to integrate sensors into materials. Surprisingly, it has been shown that the integration of microsensors into different materials is possible with the help of microsystem technology. New microsensors have been developed, which can be embedded in various materials such as elastomers, epoxy resin, carbon fiber composite materials, steel and aluminum. For this purpose, essentially the materials required for sensor functionality are adapted to the mechanical and thermal properties of the material in which it is to be integrated. Microsystem technology offers the technological advantage of using as little material as possible for the production of a microsensor and therefore introducing as little foreign material as possible into the linear guide. Therefore, after completing the injection, only minimal weakening of the material is to be expected. The technological prerequisites for the production of such structures require clean room technology. The temperature load of the linear unit when embedding the sensor depends on the embedding process: room temperature of up to 180° C. can occur when using an adhesive. When soldering, it depends on the choice of the solder. There are low-melting solders, called soft solders, which are processed in a temperature range from about 60° C. to about 450° C. [Celsius], and hard soldering processes which are processed in a temperature range from about 450° C. to about 800° C. Alternatively, the sensor can be welded or applied by means of injection (for example, flame spraying). In a particularly preferred embodiment, the microsensor is applied to a carrier substrate made of a metal, preferably a metal which is at least similar to the solder or a steel which is at least similar to the steel of the guide rail. With the subsequent process of embedding, this carrier substrate is absorbed materially, i.e. at the molecular level, and only the protective layer(s) and functional layer(s) of the microsensor remain as foreign inclusions in the depression. This results in a very good mechanical transmission of the deformations of the guide rail to the embedded microsensor.

Using such material-integrated microsensors, it is possible to extract data from a component in order to determine the state of the component. For example, microsensors are integrated into a guide rail in order to measure the thermal and mechanical stresses in the guide rail. As a result, it is also possible to draw conclusions on the carriage, such as the loads and deformations, the temperature as well as production errors and damage. In particular, together with a data sheet supplied by the manufacturer, or the FEM model, the deformations determined by means of the material-integrated microsensors can be used to calculate the previously described information on the carriage. The microsensor can be embedded both during casting, but also after production by soldering, gluing or partial casting.

For status monitoring, the essential parameters are temperature and force. A force acts on the area of the guide rail in which the guide carriage or carriage is located. The force is transmitted from the guide carriage to the guide rail by means of guide rollers and/or hydrostatic bearing pockets. These forces can be measured with such microsensors. A very simple implementation of such microsensors is a simple meandering structure of a metal, for example gold, chromium, platinum or others, as well as metal alloys, on a substrate of, for example, ceramic and/or metal and a blend. However, the sensor structure must be completely insulated, as otherwise electrical short-circuiting will occur due to embedding in the electrically conductive material, usually steel, of the guide rail. The meandering structure of metal preferably has a layer thickness of less than 1 μm [micrometer] and can be produced very simply by known microtechnical methods. Insulation can also be applied by microtechnical methods. This structure can be installed in a guide rail.

If the guide rail is deformed as a result of the force, the sensor structure also deforms, which is measurable on the basis of the geometrical (metal) or the piezo-resistive (semiconductor) effect in the change in the resistance. A suitable position is preferably determined by means of an FEM [finite element method] simulation. It is preferably not in the greatest load range, but sufficient deformations take place in order to be able to measure forces. When selecting the position, the integrity and in particular the stability or stiffness of the guide rail should preferably be taken into account. In addition to the integration of only a single strain gage, a number of strain gages can also be integrated in order to be able to measure torque or bending forces, preferably in the manner indicated above. In a preferred variant, the microsensor is inserted into a depression, which is open, for example from the joining surface, of the guide rail or to this side, line connections are arranged to the microsensor. The depression is preferably completely closed.

Alternatively, at least one microsensor is introduced directly during production, for example, casting or continuous casting of a steel rail. The microsensor is then arranged in a notional depression which coincides with the molding dimensions of the microsensor together with partial sections of the line connections which extend out of the guide rail.

The meandering structure also allows temperatures to be measured. Alternatively or additionally thermocouples can be used to measure the temperature. The measurement of the force can also be performed with a piezo element. In the case of a piezo element, as a rule, a ceramic material is used which, owing to its particular crystal structure under load, carries out a deformation which leads to a charge displacement in the crystal. This charge displacement causes a proportional voltage change. This can be used as a measuring signal.

In an alternative embodiment, which can also be used in combination with the above-described embodiment, at least one microsensor is applied to a surface, for example, a guide rail or a threaded rod of a spindle drive of a linear guiding device, namely a sensor surface. Therefore, the loads acting on the component can be measured during operation and the remaining life of the monitored component can be determined from these measured values. Such sensor systems are suitable for all types of linear guiding devices. The example of a guide rail explains an application. The guide rail is either screwed to the machine from above or below. A guide carriage runs over the guide rail and therefore performs a linear movement.

The guide rail deforms as a result of the forces and moments occurring during operation. The deformation is proportional to the occurring force and can be detected via strain gages. The strain gages are either glued as finished sensor elements (film strain gages) and are manually wired or thin-layered directly on the guide rail or integrated into the guide rail.

In a further advantageous embodiment of the linear guiding device, a number of microsensors are arranged over a length of at least one sensor surface, preferably the density of the microsensors being higher in a processing section, preferably in a machine tool than in a pure transport section.

The number of measuring points in the longitudinal direction of the guide rail is variable. The measuring points can be arranged equidistant to one another or, in the area of larger loads, can also be arranged in a higher density, that is to say with a smaller distance from one another in comparison to other lengths of the guide rail. In a machine tool, for example, it is possible to provide a higher density in a machining section and to provide a lower density on a transport section between machining section and tool change. Also, the arrangements in the sections should preferably be different because, for example, no or only small loads are introduced into the guide rail in a transport section, which differ from the pure inertial forces and weight forces of the carriage. A machining section is a section of a linear guiding device in which machining forces can occur, for example during milling, both on the tool side and on the workpiece side. These sections can usually be clearly defined. As machining sections, tool changing positions can also be considered, provided considerable forces are introduced here. All other sections are generally pure transport sections, into which a carriage travels from one position (for example to the tool change) into another position (for example, a section of the machine). Therefore, the costs for individual machine tools, or other applications, can be significantly reduced.

According to a further aspect of the invention, a feed axis with two parallel linear guiding devices is proposed as guide rails according to the above description, which are adapted to guide a carriage.

The carriage is thereby mounted by means of balls, rollers or other rolling elements, or is supported hydrostatically. By means of this feed axis, the load on the feed movement of the carriage on the linear guiding devices can be ascertained. For this purpose, the microsensors, preferably externally, are connected to one another and a stored movement model of the feed axis or the carriage is used. In doing so, overloads are detected and targeted remedial measures can be taken, such as a new alignment of a bearing.

According to a further aspect of the invention, a machine tool with at least one feed axis as described above is proposed.

In this case, the feed axis is designed for feed movements from a carriage for a workpiece or for a machining tool, or for moving a tool changer in each case along a translatory space axis. In this case, incorrect loads as well as incorrect operation of the machine tool can be detected. Preferably, sensor data is read out by external, measuring electronics and is automatically interpreted by means of machine tool stored movement models, and preferably just-in-time.

In the case of a ball screw drive, the strain gage is preferably mounted on the surface of the thread drive between the drive, i.e. the motor or the gear, and threads of the threaded drive. Therefore, on the cylindrical surface of the drive.

According to a further aspect of the invention, a method for the thin-film application of a microsensor is proposed on a linear guiding device, which has at least the following steps:

a. Applying an electrically insulating first layer on a sensor surface to be detected by a linear guiding device;

b. Applying an electrically conductive second layer on the first layer;

c. Patterning the second layer;

d. Applying an electrically insulating and mechanically robust third layer by means of which the second layer is electrically insulated externally and mechanically protected, the third layer being preferably formed from aluminum oxide; and

e. Before, during, or after step b. Applying line connections for connecting the second layer to a measuring device.

According to this method, it is proposed to produce at least one microsensor in thin-film technology directly on the linear guiding device. The special feature is that the linear guiding device forms the base substrate here and the microsensor is not initially produced separately and has to be subsequently joined. For this purpose, a first layer, called an electrical insulation layer, is first deposited on the guide rail. The second layer, called the sensor layer, is subsequently deposited on this. Typical strain gage alloys as stated above are advantageous, namely constantan, NiCr or PtW, but also layers of a semiconductor material. Subsequently, the sensor layer is patterned. This can be done by means of etching, laser or electrochemical removal. The feed lines or the line connections are also preferably produced in this step. They can either be made from the same material as the sensor layer or from another electrically conductive material. Finally, a third layer, which is electrically insulated, is applied to protect the sensor layer. For this purpose, using a wear-resistant layer such as, for example, aluminum oxide is an advantage.

In a further advantageous embodiment of the method for applying a thin-film microsensor, before step a. in a step a1. a depression of at least the depth and of at least the surface area of the microsensor is introduced into the sensor surface to be detected.

In this preferred embodiment, at least one microsensor is protected very well from mechanical wear by being protected laterally by the material of the linear guiding device. As a result, handling such a linear guiding device during transportation and assembly is normal.

In a particularly preferred embodiment, at least one recessed structure is introduced into the linear guiding device during or after the production of the blank, for example by means of forging and/or rolling, into a sensor surface for arranging at least one microsensor. The first layer is applied to this structure, followed by the second layer. Now, the parts of the second layer, which form the conductor track and, if appropriate, the connections for the line connections, lie below the desired surface of the relevant sensor surface in the recessed structure. Subsequently, the parts of the second layer projecting from the recessed structures are removed in a milling process or grinding process. The milling process and/or the grinding process are not additional steps but are used in the production of the linear guiding device. Therefore, the structuring of the second layer can be integrated into the production process of the linear guiding device. Finally, the third layer is applied.

According to a further aspect of the invention, a method for introducing a microsensor to a linear guiding device is proposed, wherein the microsensor is preferably a film sensor which has at least the following steps:

i. Arranging the microsensor at a predetermined position;

ii. Casting and/or soldering at least a part of the linear guiding device means to the positioned microsensor;

iii. Before, during or after step i. Positioning of line connections on the microsensor for a measuring device.

New microsensors have been developed which can be embedded in various materials such as elastomers, epoxy resin, carbon fiber composite materials, steel and aluminum. For this purpose, reference is made to the above description. The technological prerequisites for the production of such structures require clean room technology. With the aid of such integrated microsensors it is possible to extract data from a component in order to determine the state of the component. For example, microsensors are integrated into a guide rail in order to measure the thermal and mechanical stresses in the guide rail. As a result, conclusions can also be drawn on the carriage. Conclusions are, for example, the position, speed, prestressing of the carriage as well as the temperature of rolling elements and a breakage or damage of a rolling element. For this purpose, known properties can be used from the carriage data sheet and/or the linear guide rail, for example the spring characteristics. The microsensor can be embedded both during steel casting, but also after production by soldering or partial casting.

A suitable position is preferably determined as described above by means of an FEM simulation.

Strain gages are usually glued flat to the component to be inspected. In a preferred embodiment, however, a strain gage is mounted in a depression, for example, a bore. The microsensor is introduced into this depression and is fixed by means of a gate of metal, plastic, preferably an epoxy, and is mechanically connected to the linear guiding device. In order to keep the diameter of the depression as small as possible and yet be able to accommodate a strain gage with as many meanders as possible, and therefore with a high measuring sensitivity, but also even wider, the film sensor is preferably rolled up by the insertion axis into the depression. If the microsensor is rolled, the microsensor is located on the wall of the, preferably bore-shaped, depression in a large area. As a result, the distance to the solid material of the linear guiding device is low and the measurement sensitivity is increased compared to the integration of a disc-shaped element with a matrix material.

Alternatively, the sensor is applied to a steel substrate and is inserted into a depression. A very good transfer of the deformation to the strain gage is achieved by a subsequent material-bonded, preferably welded or cast-in connection, and at the same time weakening by the depression is (almost) completely eliminated. This step is preferably carried out before the guide rail is heat treated.

In the case of a slight weakening, a strain gage can also be accommodated in a ball screw drive.

In addition to the integration of only a single strain gage, a number of strain gages can also be integrated in order to be able to measure torque or bending forces, preferably in the manner indicated above. In a preferred variant, the microsensor is inserted into a depression which is open from the joining surface of the guide rail, or to this side, line connections are arranged to the microsensor. The depression is preferably completely closed.

Alternatively, at least one microsensor is introduced directly during production, for example, casting or continuous casting of a steel rail. Then, the microsensor (in the case of the final product) is arranged in a notional depression, which coincides with the molding dimensions of the microsensor together with partial sections of the line connections which extend out of the guide rail.

The meandering structure also allows temperatures to be measured. Alternatively or additionally thermocouples can be used to measure the temperature. The measurement of the force can also be performed with a piezo element. In the case of a piezo element, as a rule, a ceramic material is used which, owing to its particular crystal structure under load, carries out a deformation which leads to a charge displacement in the crystal. This charge displacement causes a proportional voltage change. This can be used as a measuring signal.

In accordance with a further advantageous embodiment of the method for introducing a microsensor, the linear guiding device is, preferably completely, finished before step i except for at least one depression for at least one microsensor, and the microsensor is positionable in step i by means of the depression, and in step ii. The depression is closed by partial casting and/or soldering and the microsensor is fixed.

This method allows for the addition of at least one microsensor after the production of a linear guiding device, without disadvantageous effects for the measurements. In particular, a mechanical connection quality which corresponds to a one-piece production or at least very close to it is achieved because the alloy for the partial casting is identical or at least mechanically similar to the material of the linear guiding device, or in the case of soldering significantly better mechanical force lines are achieved than with gluing. Moreover, the mechanical material characteristics of a soldering agent, in particular during brazing, welding or injection, are often very similar to the mechanical and thermal material characteristics of the material of the linear guiding device in the region of an operating temperature of a machine tool.

According to a further advantageous embodiment of the method for introducing a microsensor according to an embodiment according to the above description, the linear guiding device comprises least one of the following treatment steps after step ii, preferably supplied after step iii:
Surface hardening of the linear guiding device; and
starting the linear guiding device.

A heat-treated guide rail must often not be heated above 120° C. (Celsius) because otherwise the (martensitic) crystal structure of the guide rail will be altered and the mechanical properties will be impaired. In particular, the properties achieved during hardening (freezing of the martensitic crystal structure) are lost, the guide rail becomes soft and the surface does not withstand the surface pressures. However, many microsensors are quite suitable for high-temperature use and can therefore be introduced at an early stage of guide rail production. The subsequent heat treatments do not damage the microsensors. In a conventional production method of a conventional linear guiding device, the basic shape (blank) is first produced by a forming process, for example by forging and/or rolling. The functional surfaces are then milled and/or ground. Preferably, at least one microsensor is applied after the shaping, preferably after the milling and/or grinding. Finally, the linear guiding device is supplied with a corresponding heat treatment.

According to a further aspect of the invention, a computer-executable method is provided for detecting loads in a linear guiding device with at least one microsensor according to the above description, as well as a computer-readable device comprising this computer-executable method. This computer-executable method is characterized mainly by the fact that numerous strain gages are provided and a deformation of the sensor surface in the measuring orientation causes a resistance change to at least one of the strain gages, wherein the shape and E-modulus of the linear guiding device, the orientation and position of the strain gages are stored.

The applied linear force and/or the applied torque is calculated on the basis of the respective resistance changes from the strain gages together with the stored values of the form, the E-modulus and position, the linear force applied and/or the applied torque is calculated, preferably the life time being extrapolated and/or measures taken to increase the service life.

The data from the linear guiding device is preferably provided by a manufacturer of the linear guiding device and can be present in a variable manner by hand or fixedly and inaccessibly stored. For example, the recorded values of the strain gages are calculated based on an FEM simulation. Moreover, in a preferred embodiment, the movement of the carriage is detected on the linear guiding device, preferably together with data determined in the same way by a further linear guiding device with the same feed axis. A mechanical movement model of the carriage is stored for this purpose.

In a preferred embodiment, not only a second linear guide of the same feed axis is compared, but via a linkage and evaluation of the data via the Internet, all measurements on the same guide type can be compared in different machines under different ambient conditions. Damage models are automatically generated and the machines at user A learn automatically from the machines at user B. The application can of course also be used via a company intranet, so that company know-how does not reach third parties.

### BRIEF DESCRIPTION

The above-described invention is explained in detail below in the technical background, with reference to the accompanying drawings showing preferred embodiments. The invention is in no way limited by the purely schematic drawings, where it is to be noted that the drawings are not dimensionally accurate and are not suitable for defining size ratios. It is shown in

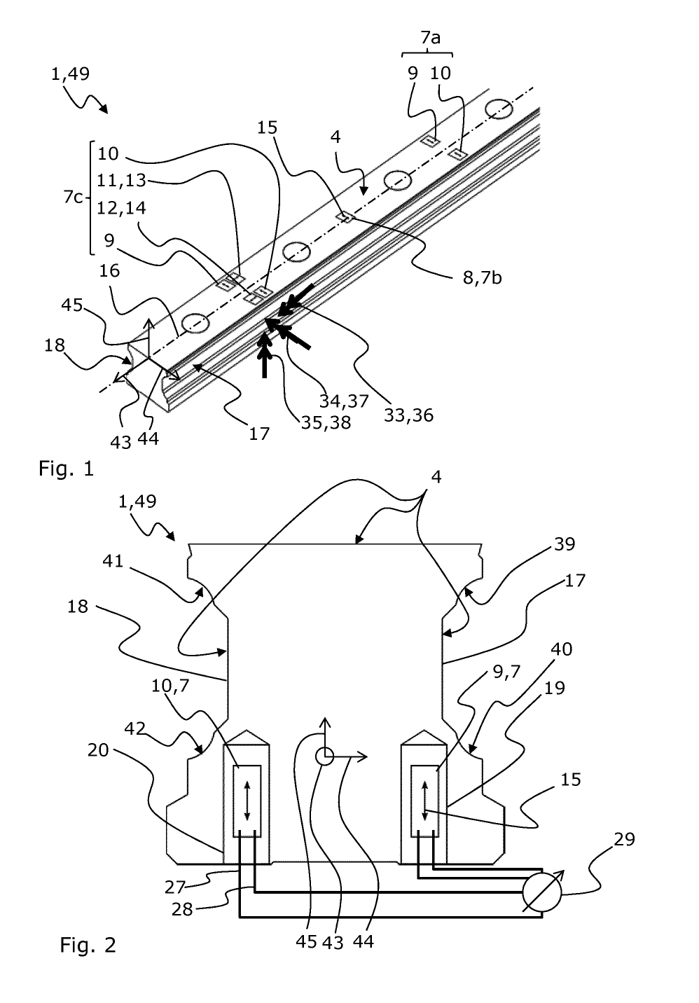

FIG. 1: a linear guiding device with different measuring arrangements;

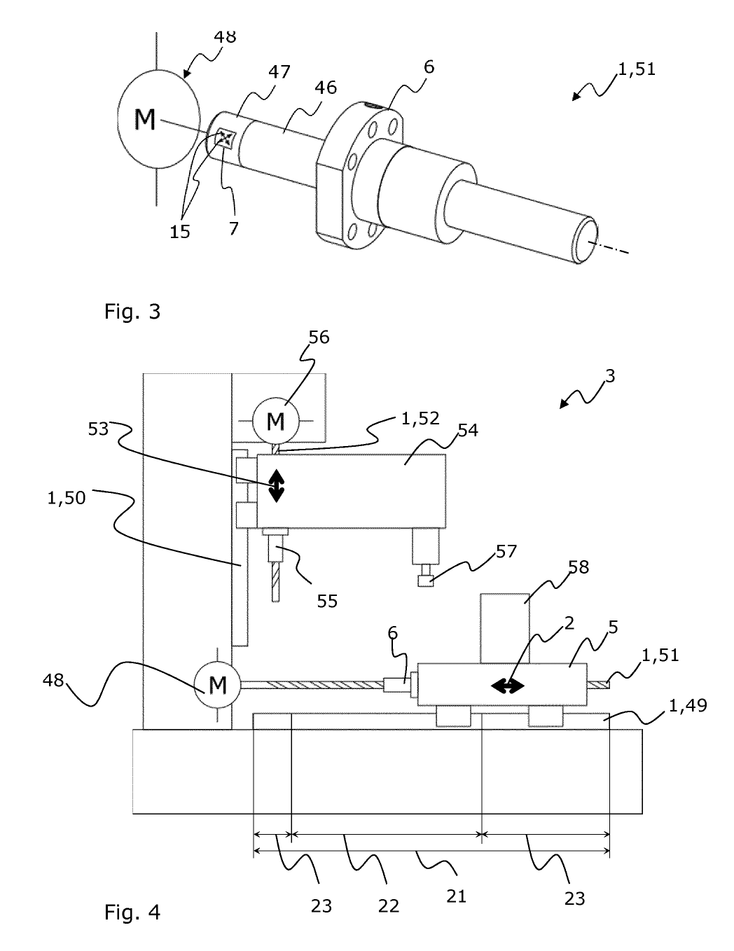

FIG. 2: a guide rail in cross-section;

FIG. 3: a spindle drive with spindle nut;

FIG. 4: a machine tool; and

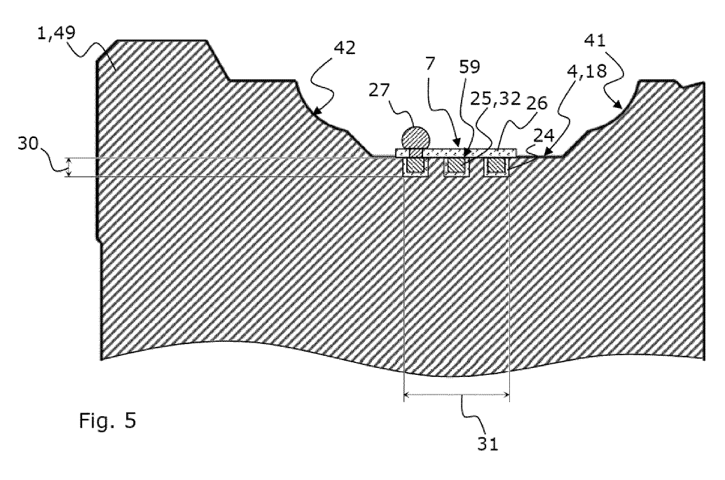

FIG. 5: a microsensor on a sensor surface in the section.

In FIG. 1 shows a linear guiding device 1, here a profile rail for a ball bearing carriage (not shown). On one of the possible sensor surfaces 4, in this case the top side of the profile rail, between the (directly loadable) first bearing side 17 and the second bearing side 18, various configurations of microsensors 7 (7a, 7b, 7c) are presented with in part a number of expansion strips, which are arranged with partly different measuring alignments 15 (double arrow). In this case, the linear guiding device 1 can be screwed several times from the top along the center line 16. The center line 16 defines the x-axis 43, to which the z-axis 45 is defined in a conventional manner in the installation upwards, as shown in the figure. The alignment of the y-axis 44 results from the usual standard as shown. In addition to the linear guiding device 1, an x-force 33 (which will have no influence because it is the only free direction) and an x-torque 36 with a common double arrow are shown because of the better displayability. Similarly, a y-force 34 and a y-torque 37, as well as a z-force 35 and a z-torque 38 are shown.

In the case of the first microsensor 7a, two strain gages 9 and 10 are arranged on the right and left of the central line 16 with their measuring direction 15 transversely with respect to the center line 16. In the case of tensile loading (z-force 35 in the direction of the arrow), both strain gages 9 and 10 are compressed, (force 35 opposite the direction of the arrow), both strain gages 9 and 10 are stretched. In the case of a force introduction from the side (y-force 34), a strain gage is compressed (at y-force 34 in the direction of the arrow strain gage 9), the other stretched (then strain gage 10). The same measurement arises at a z-torque 38 and an x-torque 36. With this arrangement, in addition to the absolute height, the direction of the force introduction can also be determined.

In the case of the second microsensor 7b, only a strain gage 8 which is aligned with its measuring direction 15 transversely with respect to the center line is used. This can only distinguish between tensile load and compressive load (compression or expansion), but can only detect conditionally lateral forces and moments. However, this variant represents a cost-effective alternative.

In the case of the third microsensor 7c, the two measuring strain gages 9 and 10, unlike the first microsensor 7a, do not lie in a line, but are offset with respect to one another along the center line 16. In the case of the third microsensor 7c, all measured values can nevertheless be recorded as in the case of the first microsensor 7a. In addition, the speed and the direction of movement of the guide carriage can be additionally detected in dynamic use, that is to say, as the guide carriage moves. Furthermore, two further strain gages 11 and 12 are shown in the third microsensor 7c, the measuring orientation 15 of which is rotated by 90° relative to the measurement direction 15 of the strain gages 9 and 10. Thus, although these strain gages 11 and 12 do not measure the deformation of the linear guiding device 1, the linear guiding device 1 is very rigid in this direction. However, temperature compensation is possible because they are subjected to the same thermal influences as the strain gages 9 and 10 and serve as resistance temperature sensors 13 and 14.

The microsensors 7 can be read out by corresponding electronics. Expediently, they are interconnected in a Wheatstone measuring bridge. The measurement can be carried out via a two-wire measurement, three-wire measurement, four-wire measurement or six-wire measurement.

The microsensors 7 can be read out either individually, with or without temperature compensation, or in the case of two strain gages (microsensors 7a and 7c) arranged in a crossed half bridge, also with or without temperature compensation. In the case of the crossed half bridge, however, the information about laterally acting forces and torques about the longitudinal axis of the guide rail is lost. However, the interconnection is twice as sensitive as the second microsensor 7b.

In FIG. 2 shows a linear guiding device 1, in this case a profile rail with a basic construction as in FIG. 1, shown in cross-section. In this case, the ball bearing surfaces 39, 40, 41 and 42 on the two bearing sides 17 and 18 are clearly visible. Here, three possible sensor surfaces 4 are designated, wherein also the two bearing sides 17 and 18 represent suitable surfaces. In this example, the microsensors 7 are not arranged on the surface. Rather, the strain gages 9 and 10 are in each case arranged in depression 19 or 20, which are here, for example, first drilled and then filled by partial casting after the positioning of the strain gages 9 and 10. Therefore, the microsensors 7 are embedded in the linear guiding device 1. The determined measurements thereby refer approximately to the lateral sensor surfaces 4 on the bearing side 17 or 18. The measuring direction 15 is in this case configured in particular for the z-force 35 along the z-axis 45 (equal tensile load or pressure load on both strain gages 9 and 10) and for an x-torque 36 about the x-axis 43 (in each case opposite tensile load and pressure load on the strain gages 9 and 10), as well as for a transverse force (y-force 34) along the y-axis 44 (in each case opposite tensile load and compressive load on the y-axis strain gages 9 and 10). The measuring signals, shown here purely schematically, are forwarded by means of the first and second line connections 27 and 28 to measuring device 29, where they are connected to a measured value, for example, by means of a Wheatstone bridge.

In FIG. 3, a linear guiding device 1 is shown as a ball screw drive 51, on which an axially movable spindle nut 6 is arranged. The spindle nut 6 is displaceable in the region of the threaded portion 46. For this purpose, the ball screw drive 51 is rotatable by means of drive 48. The ball screw drive 51 also has a shaft section 47 on which no thread is arranged. A microsensor 7 is arranged in shaft section 47, which is preferably designed as shown here with two measuring directions 15 which are arranged orthogonally to one another and are inclined by 45° to a vertical cross-sectional plane. This allows torque loads occurring in the ball screw drive 51 to be detected.

In FIG. 4, a simplified machine tool 3 is shown which has a first feed axis 2 for a workpiece 58 and a second feed axis 53 for a tool 57. By means of a first ball screw drive 51, a first carriage 5 can be moved along the first feed axis 2 on a first (paired) profile rail 49. For this purpose, the first spindle nut 6 is firmly attached to the guided first carriage 5. By means of the first drive 48, the first ball screw drive 51 is rotated in a controlled manner. Similarly, the second feed axis 53 is equipped with a second drive 56, a second ball screw drive 52 and a second spindle nut 55, and the second carriage 54 is guided via a second (paired) profile rail 50. It is suggested here to arrange microsensors (not shown here) depending on the loads on the length 21 of the first profile rails 49. Two pure transport sections 23 are formed in which no processing can take place and a machining section 22 arranged in between, in which tool 57 initiates forces on workpiece 58 and therefore onto the first profile rail 49. A transport section 23 is, for example, provided for the better removability or tensionability of workpiece 58.

In FIG. 5 a section of a linear guiding device 1 as a profile rail 49 is shown in the section. In this case, a microsensor 7 is arranged in a sensor surface 4, here the bearing side 18. In this case, the depth 30 and the (total) surface 31 are adapted to the (desired) size of the microsensor 7. Furthermore, negative structure 59 is introduced into sensor surface 4 during the shaping of the blank of the linear guiding device 1 or subsequently. The first layer 24 is then applied so that the entire structure is superimposed, but the negative structure 59 is retained at the same time. Subsequently, the second layer 25 is applied so that the negative structure 59 is, as a rule, completely filled. Regions of the first layer 24 and the regions of the second layer 25 which are not associated with the conductor track 32 extend beyond the plane of the sensor surface 4. Subsequently, for example in a grinding process, the excess parts of the first layer 24 and of the second layer 25 are also removed so that the conductor track 32, for example meandering, is produced. Thus, the patterning is carried out simultaneously with a processing step of the linear guiding device 1. Finally, the third layer 26 is applied and the line connection 27, preferably by means of soldering or wire bonding, is connected to the second layer 25, preferably by means of etching, ultrasonic machining or chip-piercing penetration of the third layer 26. Microsensor 7 is therefore well protected from mechanical influences. The first layer 24 is arranged as an electrical insulator and the third layer 26 is designed as a mechanical protection and as an electrical insulator. The second layer 25 is electrically conductive and has the desired sensor properties. This is connected to a line connection 27, which supplies the measurement signal to a measuring device 29 (not shown) (compare FIG. 2).

With the present invention, a load on a linear guiding device can be directly measured during the machine's operation.

### LIST OF REFERENCE NUMBERS

1 Linear guiding device
2 First feed axis
3 Machine tool
4 Sensor surface
5 First carriage
6 First spindle nut
7 Microsensor
8 First strain gage
9 Second strain gage
10 Third strain gage
11 Fourth strain gage
12 Fifth strain gage
13 First resistance temperature sensor
14 Second resistance temperature sensor
15 Measuring alignment
16 Center line
17 First bearing side
18 Second bearing side
19 First deepening
20 Second depression
21 Length
22 Machining section
23 Transport section
24 First layer
25 Second layer
26 Third layer
27 First line connection
28 Second line connection
29 Measuring device
30 Depth
31 Area
32 Conductor path
33 x-force
34 y-force
35 z-force
36 x-torque
37 y-torque
38 z-torque
39 First ball bearing surface
40 Second ball bearing surface
41 Third ball bearing surface
42 Fourth ball bearing surface
43 x-axis
44 y-axis
45 z-axis
46 Threaded portion
47 Shaft section
48 First drive
49 First profile rail
50 Second profile rail
51 First ball screw drive
52 Second ball screw drive
53 Second feed axis
54 Second carriage
55 Second spindle nut
56 Second drive
57 Tool
58 Workpiece
59 Negative structure

1. A linear guiding device (1) for a feed axis (2), preferably for a machine tool (3), comprising at least the following components:
At least one sensor surface (4) of the linear guiding device (1), the linear guiding device (1) being designed for the linear guidance of a carriage (5) or a spindle nut (6);
at least one microsensor (7), preferably at least one strain gage (8, 9, 10, 11, 12) and/or at least one resistance temperature sensor (13, 14), for detecting an expansion and/or compression and/or temperature of at least one sensor surface (4);
characterized in that
at least one microsensor (7) is permanently connected to at least one sensor surface (4).

2. The linear guiding device (1) according to claim 1, wherein at least one microsensor (7) has at least one strain gage (8,9,10,11,12) with a single measuring orientation (15) in at least one of the following arrangements:
Transversely on a central line (16) between two bearing sides (17, 18);
at least two strain gages (8, 9, 10, 11, 12) are respectively transverse to the measuring direction (15) and equidistant to a central line (16) between two bearing sides (17, 18);
with the measuring orientation (15) along a central line (16) between two bearing sides (17, 18).

3. The linear guiding device (1) according to claim 1, wherein at least one microsensor (7) is secured by means of at least one of the following manufacturing processes:
(7) is closed by means of the embedded microsensor (7), preferably by means of partial embedding and/or by means of soldering. (DE). WIPO Home services World Intellectual Property Organization, wherein at least one microsensor (7) is preferably a film sensor and is introduced into the recess (19, 20) in a rolled manner;
embedding at least one microsensor (7) during the casting, preferably continuous casting, of the linear guiding device (1);
extensive gluing of at least one microsensor (7) to at least one sensor surface (4); and
extensive thin-film application of the microsensor (7) on at least one sensor surface (4).

4. The linear guiding device (1) according to claim 1, wherein a number of microsensors (7) are arranged over a length (21) of at least one sensor surface (4), where the density of the microsensors (7), preferably from a machine tool (3), is higher than in a pure transport section (23), preferably from a machine tool (3).

5. A method for the thin-film application of a microsensor (7) on a linear guiding device (1), comprising the following steps:
a. applying an electrically insulating first layer (24) to a sensor surface (4) of a linear guiding device (1) to be detected;
b. applying an electrically conductive second layer (25) to the first layer (24);
c. patterning the second layer (25);
d. applying an electrically insulating and mechanically robust third layer (26) by means of which the second layer (25) is electrically insulated and mechanically protected from the outside, the third layer (26) preferably being formed from aluminum oxide; and
e. before, during or after step b. Application of line connections (27, 28) for connecting the second layer (25) to a measuring device (29).

6. The method for thin-film application of a microsensor (7) according to claim 5, wherein before step a. In a step a1. A recess (19, 20) of at least the depth (30) and at least the surface (31) of the microsensor (7) is introduced into the sensor surface (4).

7. A method for introducing a microsensor (7) into a linear guiding device (1), wherein the microsensor (7) is preferably a film sensor, having at least the following steps:
i. Arranging the microsensor (7) to a predetermined position;
ii. Casting and/or soldering at least a part of the linear guiding device (1) to the positioned microsensor (7);
iii. Before, during or after step i. Positioning the line connections (27, 28) on the microsensor (7) for a measuring device (29).

8. The method for introducing a microsensor (7) according to claim 7, wherein the linear guiding device (1), has been completed, preferably completely, before step i (7) and wherein the microsensor (7), in step i), is provided with at least one depression (19, 20) for at least one microsensor (7) by means of the depression (19, 20), and wherein in step ii. the depression (19, 20) is closed by partial casting and/or soldering and the microsensor (7) is fixed.

9. The method of introducing a microsensor (7) according to claim 7, wherein the linear guiding device (1) at least one of the following treatment steps after step ii is supplied, preferably after step iii:
Surface hardening of the linear guiding device (1); and
starting the linear guiding device (1)

10. A computer-executable method for detecting loads in a linear guiding device (1) with at least one microsensor (7) according to claim 1,
characterized in that
a plurality of strain gages (8, 9, 10, 11, 12) (8, 9, 10, 11, 12), wherein the shape and modulus of elasticity of the linear guiding device (1) determine the orientation and position of the strain gages (4) in the measuring direction (15) 8,9,10,11,12), and wherein, on the basis of the respective resistance changes of the strain gages (8, 9, 10, 11, 12) together with the stored values of the form, E-module and position the applied linear force 33,34, 35) and/or the adjoining torque (36, 37, 38) is calculated, preferably the duration of the service life being extrapolated therefrom and/or measures for increasing the service life.
